(19) United States
(12) Patent Application Publication
(10) Pub. No.: US 2026/0077950 A1
(43) Pub. Date: Mar. 19, 2026

(54) CONVEYING APPARATUS AND OBJECT PROCESSING SYSTEM

(71) Applicant: ABB SCHWEIZ AG, Baden (CH)

(72) Inventors: Yang Li, Shanghai (CN); Junjie Wang, Shanghai (CN); Shuangli Wang, Suzhou (CN); Jizhou Xie, Shanghai (CN); Keyan Zhang, Shanghai (CN); Yin Tian, Shanghai (CN)

(21) Appl. No.: 19/397,893

(22) Filed: Nov. 22, 2025

Related U.S. Application Data
(63) Continuation of application No. PCT/CN2023/095468, filed on May 22, 2023.

(51) Int. Cl. B65G 13/06; B65G 39/12; B65G 43/00

(52) U.S. Cl. CPC B65G 13/06; B65G 39/12; B65G 43/00

(57) ABSTRACT

A conveying apparatus comprises a plurality of driving rollers, configured to rotate to convey an object provided onto the plurality of driving rollers along a conveying direction a plurality of motors each motor configured to drive a respective driving roller to rotate; and at least one motor controller configured to control a subset of motors among the plurality of motors According to the example embodiments of the present disclosure, no belts or gears are required connect the driving roller to the motor. By changing sliding friction into rolling friction in this way, the number of particles and debris caused by the frictions can be reduced significantly.

### FIELD

Example embodiments of the present disclosure generally relate to the industrial field, and more particularly, to a conveying apparatus and a corresponding object processing system.

### BACKGROUND

In the manufacture of industrials, especially in the electronics industry, there is a growing need to manufacture devices in a high level of a dust free environment. Dust may be induced by frictions among the components within the devices. The dust will affect the quality of the finished product and should be reduced or even eliminated. How to efficiently reduce the dust during the conveying of the object remains a challenge to the designers.

### SUMMARY

In general, example embodiments of the present disclosure provide a conveying apparatus and a corresponding object processing system, which address the existing problems and/or any potential problems.

In a first aspect, there is provided a conveying apparatus. The conveying apparatus comprises a plurality of driving rollers, configured to rotate to convey an object provided onto the plurality of driving rollers along a conveying direction; a plurality of motors, each motor configured to drive a respective driving roller to rotate; and at least one motor controller, configured to control a subset of motors among the plurality of motors.

According to the example embodiments of the present disclosure, every driving roller is driven directly by the respective motor and no belts or gears are required in the present disclosure to connect the driving roller to the motor accordingly. By changing sliding friction into rolling friction in this way, the number of particles and debris caused by the frictions can be reduced significantly.

In some example embodiments, the conveying apparatus further comprises a plurality of first supporting rollers, provided in a first queue and configured to support the object, and the plurality of driving rollers are provided in a second queue, and the first queue and the second queue are in parallel to form a path for conveying the object.

In some example embodiments, the conveying apparatus further comprises a plurality of first guiding rollers, the plurality of first guiding rollers are provided above the plurality of first supporting rollers and configured to guide the object.

In some example embodiments, the plurality of driving rollers and the plurality of first supporting rollers are configured to rotate about a first rotational axis, the plurality of first guiding rollers are configured to rotate about a second rotational axis, the first rotational axis is perpendicular to the second rotational axis.

In some example embodiments, the conveying apparatus further comprises a plurality of second supporting rollers, provided in the second queue and configured to support the object.

In some example embodiments, the conveying apparatus further comprises a plurality of second guiding rollers, the plurality of second guiding rollers are provided above the plurality of second supporting rollers and configured to guide the object.

In some example embodiments, the plurality of driving rollers and the plurality of second supporting rollers are configured to rotate about a first rotational axis, the plurality of second guiding rollers are configured to rotate about a second rotational axis, the first rotational axis is perpendicular to the second rotational axis.

In some example embodiments, the conveying apparatus further comprises a lifting module configured to lift the object, so as to allow the object to move in a direction different from the conveying direction.

In some example embodiments, the conveying apparatus further comprises a programmable logic controller coupled to the at least one motor controller.

In some example embodiments, each of the plurality of motors is a stepping motor.

In a second aspect, there is provided an object processing system. The object processing system comprises a conveying apparatus described above.

In some example embodiments, the object processing system further comprises a robot configured to process an object conveyed by the conveying apparatus.

### BRIEF DESCRIPTION OF THE DRAWINGS

Through the following detailed description with reference to the accompanying drawings, the above and other objectives, features and advantages of the example embodiments disclosed herein will become more comprehensible. In the drawings, several example embodiments disclosed herein will be illustrated in an exemplary and in a non-limiting manner, wherein:

FIG. 1 illustrates a schematic diagram of the conveying apparatus in accordance with an example embodiment of the present disclosure;

FIG. 2 illustrates a perspective view of the conveying apparatus in accordance with an example embodiment of the present disclosure;

FIG. 3 illustrates another perspective view of the conveying apparatus in accordance with an example embodiment of the present disclosure; and

FIG. 4 illustrates a perspective view of a lifting module of the conveying apparatus in accordance with an example embodiment of the present disclosure.

Throughout the drawings, the same or similar reference numerals represent the same or similar element.

### DETAILED DESCRIPTION

Principles of the present disclosure will now be described with reference to some example embodiments. It is to be understood that these embodiments are described only for the purpose of illustration and to help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skill in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to apply such feature, structure, or characteristic in connection with other embodiments whether or not explicitly described.

It should be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

As described above, when conveying an object, the dust may be induced by frictions among the components within the devices, for example, the friction between the belt and the gear. Such a dust will influence the quality of the finished products, especially for the electronics.

A variety of approaches have been proposed to reduce the dust in object transferring industry. In a conventional approach, a roller may be used to reduce the friction, so as to reduce the number of particles and debris caused by the frictions. However, the conventional roller conveyor system uses a single motor to drive many rollers and belts or gears must be used to connect the motor to the rollers. Thus, the belt friction and gear meshing still exist and the caused number of dust cannot be avoided. Therefore, the dust free effect is so limited.

At least to address the problem existed in the conventional approaches, the present disclosure proposes a solution involving a conveying apparatus and a corresponding object processing system. According to example embodiments of the present disclosure, each driving roller is driven by a respective motor, in order to avoid using belts or gears. Therefore, the dust will be reduced by avoiding the sliding friction and gear meshing, which greatly improves the dust free effect in the conveying route.

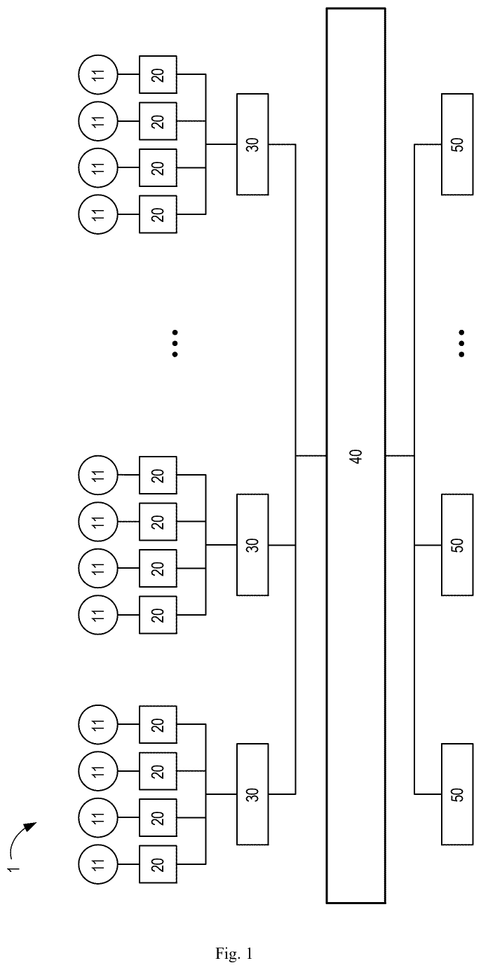

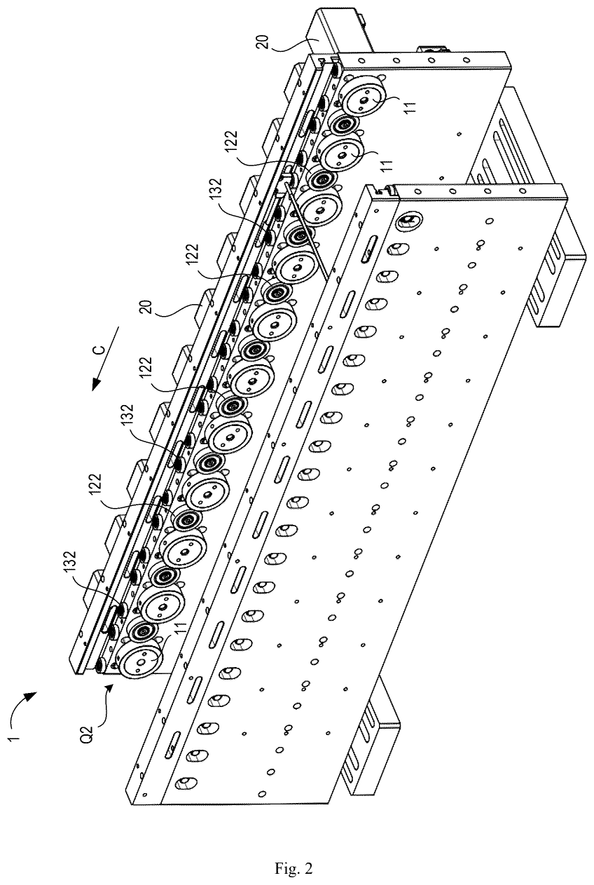

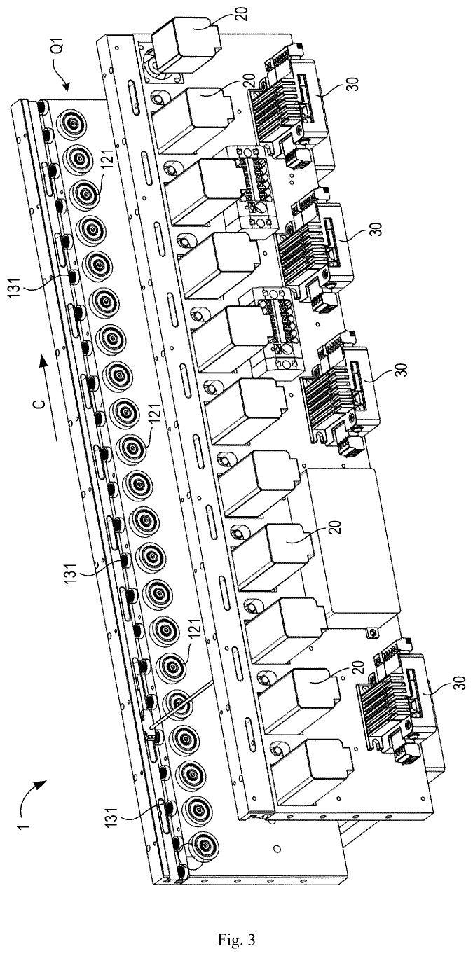

Example embodiments of the present disclosure will be described in more detail hereinafter in accordance with FIGS. 1-4, wherein FIG. 1 illustrates a schematic diagram of the conveying apparatus 1 in accordance with an example embodiment of the present disclosure, FIG. 2 illustrates a perspective view of the conveying apparatus 1 in accordance with an example embodiment of the present disclosure, and FIG. 3 illustrates another perspective view of the conveying apparatus 1 in accordance with an example embodiment of the present disclosure.

As shown in FIG. 1, the conveying apparatus 1 includes a plurality of driving rollers 11 and each driving roller 11 is equipped with a motor 20. The driving roller 11 is used to convey an object, which is provided on the driving roller 11, to move along a conveying direction C. As shown in FIG. 2, the plurality of driving rollers 11 may be arranged in a queue. The object (not shown) may be a workpiece being handled or a pallet to support the workpiece. The type, the number or the shape of the object would not be limited by the present disclosure. Any type, any number or any shape of the object is possible, as long as the object may be placed onto the driving rollers 11.

The driving rollers 11 may be driven to rotate by the respective motor 20. The motor 20 may be provided behind the each respective driving roller 11, so they are partially visible in FIG. 2. The plurality of motors 20 are shown in FIG. 3, and their number and positions match the number and the positions of the driving roller 11 (not shown in FIG. 3). The motor 20 will drive the respective driving roller 11 to rotate. By means of the rotation of the driving rollers 11, the object provided onto the driving rollers 11 will be conveyed along the conveying direction C. According to the example embodiments of the present disclosure, every driving roller 11 is driven directly by the respective motor 20. Compared with the conventional approaches where one motor drives more than one driving roller 11 by belts or gears, no belts or gears are required in the present disclosure to connect the driving roller 11 to the motor 20. By changing sliding friction into rolling friction in this way, the number of particles and debris caused by the frictions can be reduced significantly.

FIG. 2 illustrates eleven driving rollers 11 and FIG. 3 illustrates corresponding eleven motors 20. It could be understood that other numbers of the rollers 11 and the motor 20 are possible for conveying the object according to the length of the conveying path.

With reference back to FIG. 1, the conveying apparatus 1 further includes at least one motor controller 30, and the motor controller 30 is configured to control a subset of motors among the plurality of motors 20. In the example embodiments as shown in FIG. 3, four motor controllers 30 are included to control the eleven motors 20. For example, among the four motor controllers 30, the first motor controller 30 may be used to control the first motor to the third motor, the second motor controller 30 may be used to control the fourth motor to the sixth motor, the third motor controller 30 may be used to control the seventh motor to the ninth motor, and the fourth motor controller 30 may be used to control the tenth motor to the eleventh motor. It is to be understood that the mapping among the motors 20 and the motor controllers 30 are merely illustrative, but not restrictive. Any mapping among the motors 20 and the motor controllers 30 are possible, and the specific mappings are not limited to embodiments of the present disclosure. In alternative example embodiments, some motor controllers 30 may control more or less motors 20. For example, in the schematic diagram as shown in FIG. 1, each motor 30 may be designed to control four motors 20. Also, it should be noted that the number of the motors 20 controlled by a single motor controller 30 are not necessarily the same.

In some example embodiments, if the number of the motors 20 within the conveying apparatus 1 is not so much, only one motor controller 30 is also possible.

According to example embodiments of the present disclosure, by allowing some motors 20 to share the same motor controller 30, the number of the motor controllers 30 can be reduced by a great amount. Since the motor controller 30 is a relatively expensive components within the conveying apparatus 1 compared to the motors 20, the example embodiments according to the present disclosure will achieve the dust free effect in a cheap manner by reducing the number of the motor controllers 30.

In some example embodiment, each of the plurality of motors 20 may be a stepping motor. With these embodiments, by making some stepping motors to share a single motor controller 30, the working of the stepping motors will not be influenced in comparison to the scenario where each motor 20 is equipped with one motor controller 30.

With reference back to FIG. 1, the conveying apparatus 1 further includes a programmable logic controller (PLC) 40 and the motor controllers 30 may be coupled to the programmable logic controller 40. The programmable logic controller 40 may send instructions to the motor controllers 30 to command the motor controllers 30 to control the motors 20. The driving rollers 11 may be rotated accordingly to convey the object along the conveying direction C.

As shown in FIG. 1, the conveying apparatus 1 may further include one or more sensors 50 to assist in the normal operation of the conveying apparatus 1.

As shown in FIG. 3, the conveying apparatus 1 may further include a plurality of first supporting rollers 121. The first supporting rollers 121 are provided in a first queue Q1 and they are faced to the driving rollers 11. The first supporting rollers 121 and the driving rollers 11 together form a path for conveying the object. When the object is driven by the driving rollers 11 to move along the conveying direction C, it may be supported by the driving rollers 11 at one side and be supported by the first supporting rollers 121 at the other side. With these example embodiments, the objects can be remained on the path without falling from it.

In some example embodiments, no motors are provided to the first supporting rollers 121 and the first supporting rollers 121 can rotate about respective rotational axis with the movement of the object. The sliding friction between the object and the first supporting rollers 121 ensures that very little dust or even no dust will be generated. Moreover, since no motors are provided to the first supporting rollers 121, the cost of the conveying apparatus 1 will be remained in a low level.

As show in FIG. 2, the plurality of driving rollers 11 are provided in a second queue Q2. With also reference to FIG. 3, the first queue Q1 and the second queue Q2 may be in parallel to each other to form the path for conveying the object.

As show in FIG. 3, in some example embodiments, the conveying apparatus 1 may further include a plurality of first guiding rollers 131. The plurality of first guiding rollers 131 are provided above the plurality of first supporting rollers 121. When the object is supported and conveyed by the first supporting rollers 121, the first guiding rollers 131 may touch a first side face of the object to guide the movement of the object.

In the example embodiment shown in FIG. 3, a first rotational axis about which the plurality of first supporting rollers 121 rotate is perpendicular to a second rotational axis about which the first guiding rollers 131 rotate.

According to the example embodiments, the supporting rollers at the bottom and guiding rollers at the side are provided, to change all sliding friction into rolling friction. In this way, the dust can be reduced.

With reference to FIG. 2, in the second queue Q2, the conveying apparatus 1 may also include a plurality of second supporting rollers 122. The second supporting rollers 122 are designed to support the object when the object is being conveyed by the driving rollers 11. As shown, each of the plurality of second supporting rollers 122 is provided between two adjacent driving rollers 11. In this way, the second supporting rollers 122 can “fill the gaps”between the driving rollers 11 to avoid the object from falling from the convey path.

Although only one side of the path is shown to include the driving rollers 11 and the corresponding motors 20 in FIGS. 2-3, it should be appreciated that this is only illustrative. Depending on the specific scenario, both the sides of the path may be provided with the driving rollers and corresponding motors 20 to convey the object.

It is to be understood that even though one second supporting rollers 122 is provided between two adjacent driving rollers 11 in the example embodiment as shown in FIG. 2, this is merely illustrative, rather than restrictive. Other arrangements of the second supporting rollers 122 are possible according to the actual need, for example the dimension of the object. In other example embodiments, more than one second supporting rollers 122 may be provided between the two adjacent driving rollers 11. In other example embodiments, no second supporting roller 122 may be provided between the two adjacent driving rollers 11.

In some example embodiments, no motors are provided to the second supporting roller 122 and the second supporting roller 122 can rotate about respective rotational axis with the movement of the object. The sliding friction between the object and the second supporting rollers 122 ensures that very little dust or even no dust will be generated. Moreover, since no motors are provided to the second supporting roller 122, the cost of the conveying apparatus 1 will be remained in a low level.

As show in FIG. 2, in some example embodiments, the conveying apparatus 1 may further include a plurality of second guiding rollers 132. The plurality of second guiding rollers 132 are provided above the plurality of driving rollers 11 and the plurality of second supporting rollers 122. When the object is supported and conveyed by the plurality of driving rollers 11 and the plurality of second supporting rollers 122, the second guiding rollers 132 may touch a second side face of the object to guide the movement of the object.

In the example embodiment shown in FIG. 2, a first rotational axis about which the plurality of second supporting rollers 122 rotate is perpendicular to a second rotational axis about which the second guiding rollers 132 rotate.

In a further aspect, the example embodiments relate to an object processing system. The object processing system includes a conveying apparatus 1 described above. It is to be understood that within the whole object processing system, the object may be conveyed in different directions.

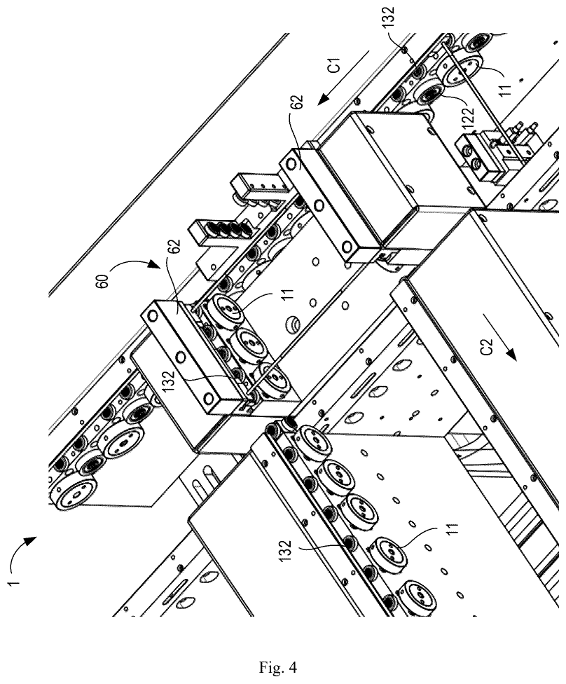

FIG. 4 illustrates a lifting module 60 of the conveying apparatus 1 in accordance with an example embodiment of the present disclosure. As shown, the object may be conveyed in two directions, i.e., a first conveying direction C1 and a second conveying direction C2. The lifting module 60 may change the conveying direction of the object between the first conveying direction C1 and the second conveying direction C2. For example, the object being conveyed in a first path along the first conveying direction C1 may be changed to a second path along the second conveying direction C2.

Within the first path, the driving rollers 11, the supporting roller 122, the guiding roller 132 described above are included. The lifting module 60 may move up and down by means of a cylinder (not shown). When the object is being conveying along the first conveying direction C1, the lifting module 60 may be in a lower position in order not to interrupt the movement of the object.

As shown, the lifting module 60 may include a stopper 62. If the conveying direction of the object is to be changed, the lifting module 60 may move up to allow the object to hit the stopper 62 and then be remained on a platform 64. The driving rollers 11, the supporting rollers 122, the guiding rollers 132 included in the lifting module 60 will actuate the object to move along the second conveying direction C2 onto the second path. The driving rollers 11, the supporting rollers 122, the guiding rollers 132 within the second path will allow the object to continue its movement along the conveying direction C2. In this way, the steering of the object can be done smoothly.

It is to be understood that more than one lifting modules 60 may be provided in the whole object processing system to allow the object to change its conveying direction as desired.

In further example embodiments, the object processing system may further include a robot. The robot may process an object conveyed by the conveying apparatus 1. In the way, the degree of automation of the object processing system can be enhanced.

Compared with the conventional approach, the example embodiments according to the present disclosure allow each driving roller 11 to be driven by a single motor 20 to avoid using belts or gears. Therefore, the dust will be reduced by avoiding the sliding friction and gear meshing. In addition, the conveying apparatus not only uses driving rollers 11 and supporting rollers 121, 122 to support the weight of the object, but also uses the guiding rollers 131, 132 provided at both sides to support the lateral force of the object, so as to avoid sliding friction between the object and the side of the conveying path during transporting. In this way, all sliding friction is changed into rolling friction and dust can be further reduced.

Compared with the conventional conveying system wherein each motor 20 needs a dedicated motor controller 30, the example embodiments innovatively proposed a solution that multiple motors 20 are controlled by a single motor controller 30, hence, this solution will reduce the number of controllers to save the cost.

It is to be understood that although the above disclosure are described by taking the object transferring scenario as examples, this is only for illustration without suggesting any limitations as to the scope of the subject matter described here the above embodiments may be used in other scenarios.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. On the other hand, various features that are described in the context of a single embodiment may also be implemented in multiple embodiments separately or in any suitable sub-combination.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A conveying apparatus, comprising:
a plurality of driving rollers configured to rotate to convey an object provided onto the plurality of driving rollers along a conveying direction
a plurality of motors each motor configured to drive a respective driving roller to rotate; and
at least one motor controller configured to control a subset of motors among the plurality of motors.

2. The conveying apparatus of claim 1, further comprising:
a plurality of first supporting rollers provided in a first queue and configured to support the object, and
wherein the plurality of driving rollers are provided in a second queue and
wherein the first queue and the second queue are in parallel to form a path for conveying the object.

3. The conveying apparatus of claim 2, further comprising:
a plurality of first guiding rollers
wherein the plurality of first guiding rollers are provided above the plurality of first supporting rollers and configured to guide the object.

4. The conveying apparatus of claim 3, wherein the plurality of driving rollers and the plurality of first supporting rollers are configured to rotate about a first rotational axis, the plurality of first guiding rollers are configured to rotate about a second rotational axis,
wherein the first rotational axis is perpendicular to the second rotational axis.

5. The conveying apparatus of claim 2, further comprising:
a plurality of second supporting rollers provided in the second queue and configured to support the object.

6. The conveying apparatus of claim 5, further comprising:
a plurality of second guiding rollers
wherein the plurality of second guiding rollers are provided above the plurality of second supporting rollers and configured to guide the object.

7. The conveying apparatus of claim 6, wherein the plurality of driving rollers and the plurality of second supporting rollers are configured to rotate about a first rotational axis, the plurality of second guiding rollers are configured to rotate about a second rotational axis,
wherein the first rotational axis is perpendicular to the second rotational axis.

8. The conveying apparatus of claim 1, further comprising:
a lifting module configured to lift the object so as to allow the object to move in a direction different from the conveying direction.

9. The conveying apparatus of claim 1, further comprising:
a programmable logic controller coupled to the at least one motor controller.

10. The conveying apparatus of claim 1, wherein each of the plurality of motors is a stepping motor.

11. An object processing system, comprising the conveying apparatus of claim 1.

12. The object processing system of claim 11, further comprising a robot configured to process an object conveyed by the conveying apparatus.
